(19) United States
(12) Patent Application Publication
(10) Pub. No.: US 2009/0009361 A1
(43) Pub. Date: Jan. 8, 2009

(54) Code 3 detector

(76) Inventor: Lance L. Say, Alhambra, CA (US)

Correspondence Address: Lance L. Say, 734 S. Stoneman Ave. #F, Alhambra, CA, 91801, US

(21) Appl. No.: 12/152,938

(22) Filed: May 19, 2008

Related U.S. Application Data
(60) Provisional application No. 60/931,212, filed on May 23, 2007.

(51) Int. Cl. G08G 1/00

(52) U.S. Cl. 340/902

(57) ABSTRACT

The Code 3 Detector is a transmitting and receiving system that is specially designed to allow police, fire, and ambulance vehicles to send a visible and/or audible alert to motorists that is heard or seen within their vehicle. This unique system is comprised of a transmitter unit, used in the emergency vehicle, and a receiver unit, which would be installed in consumer automobiles. During an emergency, emergency vehicles can activate the transmitter unit to emit a unique frequency. Passenger vehicles equipped with the receiver unit would pick up on the “tuned” circuit and thus alert the driver with visible lights and/or audible noise.

### FIELD OF THE INVENTION

This invention relates generally to an emergency vehicle detection system, and more specifically to a transmitter and receiver system that is specially designed to allow police, fire, and ambulance vehicles to send a visible and/or audible alert to motorists that is heard or seen within their vehicle.

### BACKGROUND OF THE INVENTION

Highway safety is an ongoing issue in today's mobile society. Over 200 million motor vehicles are on the road and, at any given time, emergency vehicles may be needed. When these emergency vehicles need the right-of-way, safety of the driving public becomes a problem. Emergency vehicle accidents are the number one cause of police officer deaths in the United States. In, more police officers are killed annually in auto accidents than by gunfire. Sirens, designed to warn motorists about the presence of emergency vehicles, are not always effective. Studies have shown that emergency vehicle sirens are a less than adequate means of providing advance warning of the approach of police, fire and other emergency vehicles. As automobiles have been engineered to provide a quieter, more insulated ride, sirens have become less effective. In addition, a sound limit on sirens (118 decibels) has been established by some states and industry regulations to protect citizens from irreversible ear damage and to help preserve a calm environment. With music and noisy passengers adding to the distractions of everyday driving, the need for a better warning system becomes clear. According to government statistics, just one more second of advance warning could prevent 90 percent of both rear-end and intersection accidents.

Emergency vehicles and passenger vehicles need to effectively communicate about their presence on the road. The Code 3 Detector system is a transmitting and receiving system that will help emergency vehicles to better communicate with passenger vehicles.

### SUMMARY OF THE INVENTION

The Code 3 Detector could be instrumental in minimizing the possibility of accidents between motorists and emergency vehicles that are en route to a fire, accident, or crime scene. Specifically designed to communicate from the emergency vehicle to each individual car on the road, this clever system could provide an effective second warning system that emergency vehicles are approaching. In this manner, motorists who are not aware of the wailing sirens around them due to their sound-proofing vehicle or noisy distractions inside the car would have a visual and/or audible beacon to capture their attention, right within their vehicle. The Code 3 Detector is an innovative product that could readily enhance the safety of both motorists and emergency vehicle operators.

### BRIEF DESCRIPTION OF THE DRAWINGS

Various embodiments of the present invention are illustrated by the accompanying figures, wherein:

FIG. 1 illustrates the Receiver unit and

FIG. 2 illustrates the Transmitter unit.

### DETAILED DESCRIPTION OF THE INVENTION

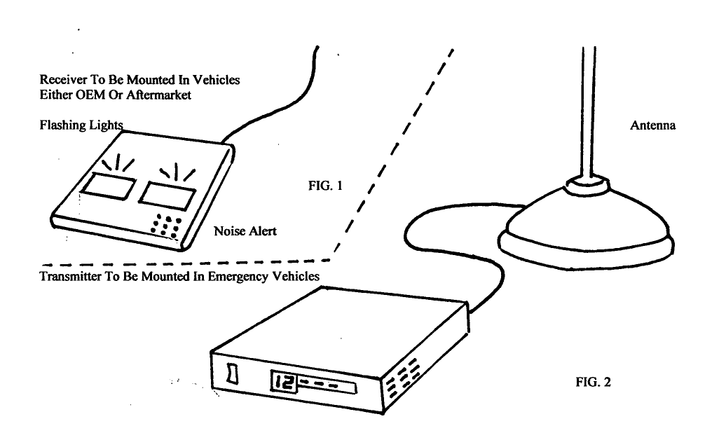

FIG. 1 illustrates the Receiver unit that is equipped with flashing red and blue light alert and a noise alert. The Receiver unit is to be mounted in passenger vehicles either OEM or aftermarket.

FIG. 2 illustrates the Transmitter unit that is equipped with an On/Off switch to emit a unique frequency through the antenna. The Transmitter unit is to be mounted in all emergency vehicles.

What is claimed is:

1. The Code 3 Detector system comprising: a transmitter unit installed in all emergency vehicles and a receiver unit installed in passenger vehicles. The transmitter unit can be activated to emit a unique frequency while en route to an emergency. The receiver unit is equipped to receive the tuned signal and thus alert the driver with visible and/or audible alerts.

2. The Code 3 Detector of claim 1, whereby the transmitter unit is comprised of electronic components and circuitry enclosed within a casing.

3. The Code 3 Detector of claim 1, whereby the transmitter unit is equipped to emit a unique frequency signal to eliminate the possibility of the receiver unit being inadvertently triggered by spurious signals.

4. The Code 3 Detector of claim 1, whereby the transmitter unit is configured with the vehicle's own power supply and activated when the switch used to engage the siren of an emergency vehicle is employed.

5. The Code 3 Detector of claim 1, whereby the receiver unit is equipped to be frequency selective and thus receives “tuned” signals only.

6. The Code 3 Detector of claim 1, whereby the receiver unit is equipped with flashing red and blue lights as a visible alert when an emergency signal is received.

7. The Code 3 Detector of claim 1, whereby the receiver unit is equipped with speakers as an audible alert when an emergency signal is received.
